(19) United States
(12) Patent Application Publication
(10) Pub. No.: US 2026/0161017 A1
(43) Pub. Date: Jun. 11, 2026

(54) Glasses

(71) Applicant: Tukeen Co., Ltd., New Taipei City (TW)

(72) Inventor: Cheng-Ju Hsu, New Taipei City (TW)

(21) Appl. No.: 18/974,955

(22) Filed: Dec. 10, 2024

(51) Int. Cl. G02C 5/20

(52) U.S. Cl. CPC G02C 5/20

(57) ABSTRACT

Glasses include a frame, two temples, two bone-conduction oscillators and two flexible metal wires. The frame is made with a predetermined profile. The temples are connected to two ends of the frame. Each temple includes a hard shell and a soft shell. The hard shell is pivotally connected to the frame and includes a chamber in communication with exterior of the hard shell. The soft shell is flexible and connected in series to the hard shell and includes a recess and a channel for connecting the recess to the chamber. The bone-conduction oscillators are inserted in the recesses. Each bone-conduction oscillator includes at least one wire extending to the chamber through the channel. The flexible metal wires extend along the channels. Each flexible metal wire is connected to a corresponding bone-conduction oscillator and a corresponding hard shell. The flexible metal wires are bendable and keepable in bent positions.

### BACKGROUND OF INVENTION

### 1. Field of Invention

The present invention relates to a wearable device and, more particularly, to glasses.

### 2. Related Prior Art

Today's eyeglasses are not only vision-correcting tools, but also accessories of fashion. Moreover, new products such as blue light-filtering glasses and sports glasses are emerging one after another. In addition, smart glasses such as augmented reality (“AR”) glasses such as those produced by Google and Meta are gradually entering the market. Glasses have become personal necessities.

Bone conduction headphones convert sound into mechanical vibrations of different frequencies and transmit sound waves through the human skulls. Users of these headphones can keep their ears open, protect their eardrums, keep listening to the environment and stay alerted.

However, glasses and bone conduction headphones are worn on the ears. Hence, a user cannot help but choose to wear glasses or bone conduction headphones, and he or she cannot wear glasses and bone conduction headphones at the same time. This is troublesome for the user

Therefore, there is a need to allow a user to wear glasses and bone conduction headphones at a same time.

### SUMMARY OF INVENTION

It is the objective of the present invention to provide glasses for enabling a user to listen.

To achieve the foregoing objective, the glasses include a frame, two temples, two bone-conduction oscillators and two flexible metal wires. The frame is made with a predetermined profile. The temples are connected to two ends of the frame. Each temple includes a hard shell and a soft shell. The hard shell is pivotally connected to the frame and includes a chamber in communication with exterior of the hard shell. The soft shell is flexible and connected in series to the hard shell and includes a recess and a channel for connecting the recess to the chamber. The bone-conduction oscillators are inserted in the recesses. Each bone-conduction oscillator includes at least one wire extending to the chamber through the channel. The flexible metal wires extend along the channels. Each flexible metal wire is connected to a corresponding bone-conduction oscillator and a corresponding hard shell. The flexible metal wires are bendable and keepable in bent positions.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of glasses according to the preferred embodiment of the present invention;

FIG. 2 is another perspective view of the glasses shown in FIG. 1;

FIG. 3 is a cross-sectional view of the glasses shown in FIG. 1;

FIG. 4 is an exploded and partial view of the glasses shown in FIG. 1;

FIG. 5 is a partial view of the glasses shown in FIG. 4; and

FIG. 6 is an enlarged partial view of the glasses shown in FIG. 3.

### DETAILED DESCRIPTION OF PREFERRED EMBODIMENT

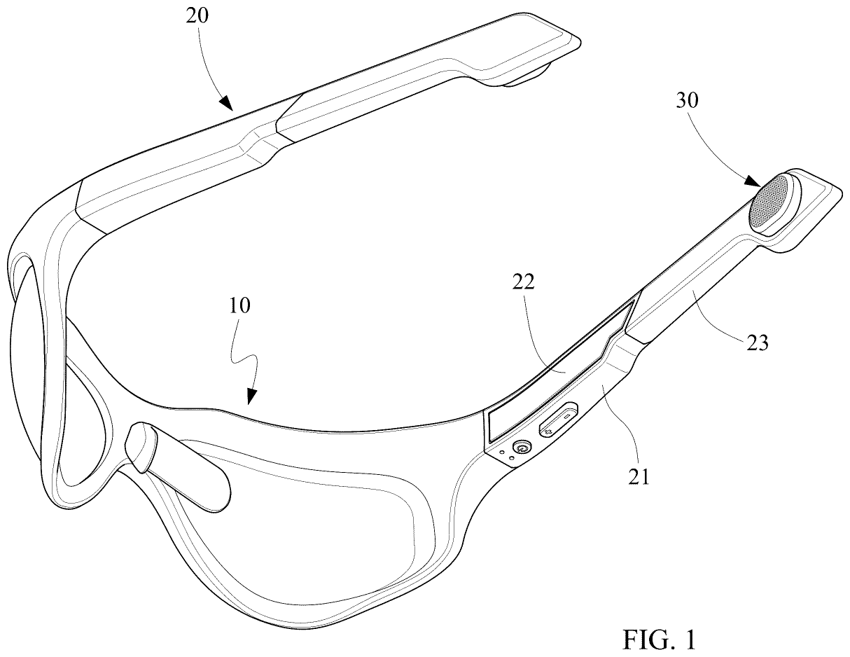

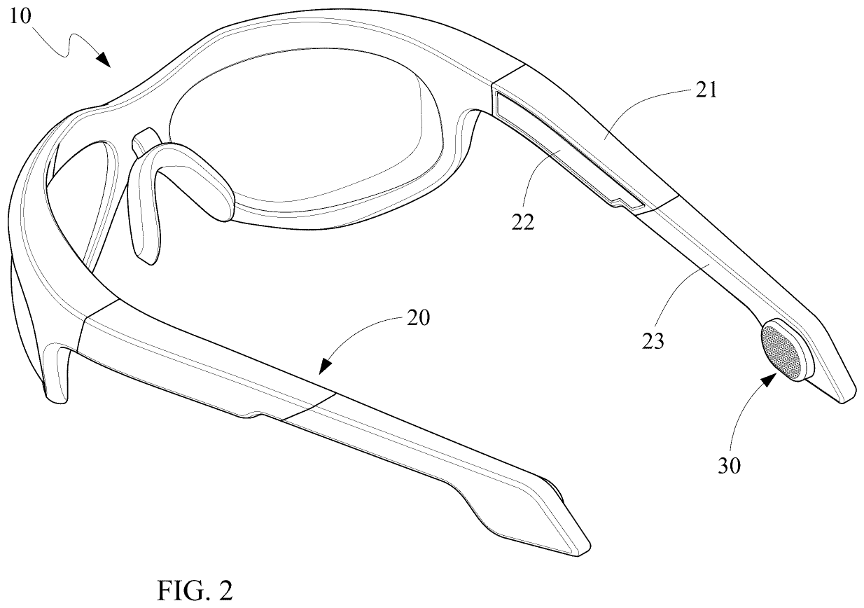

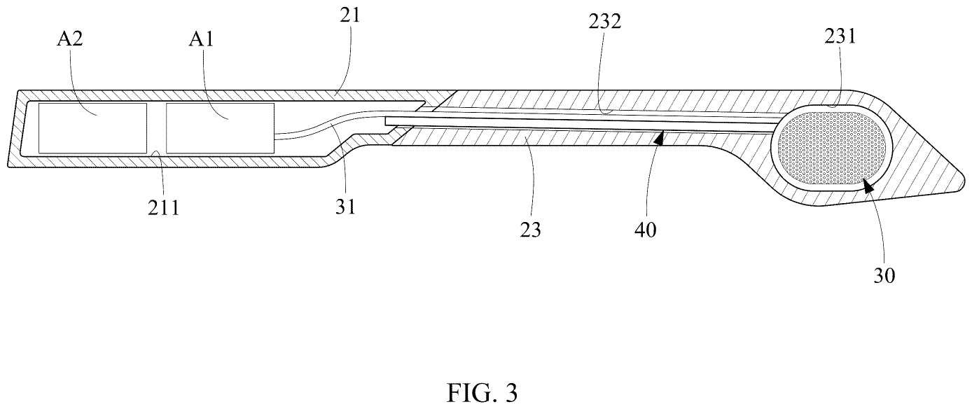

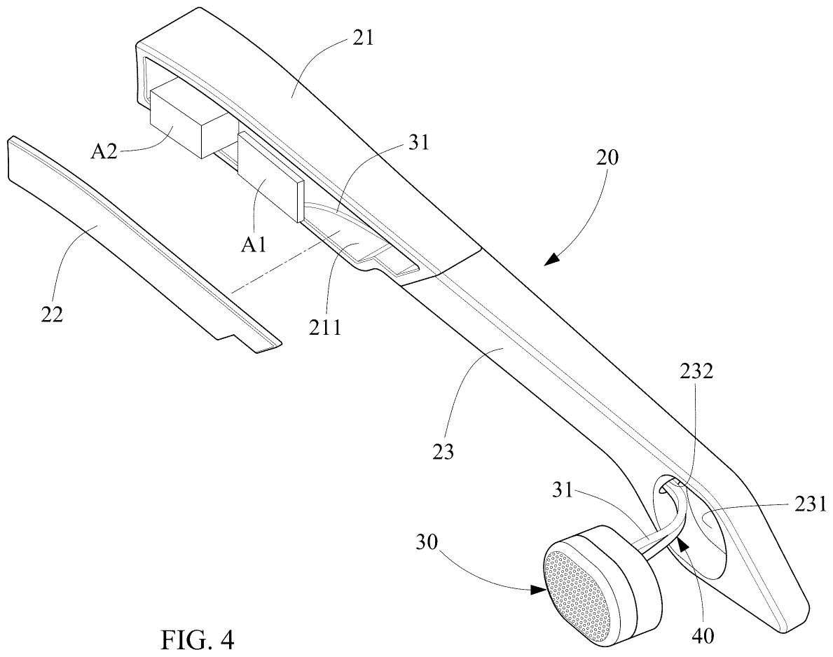

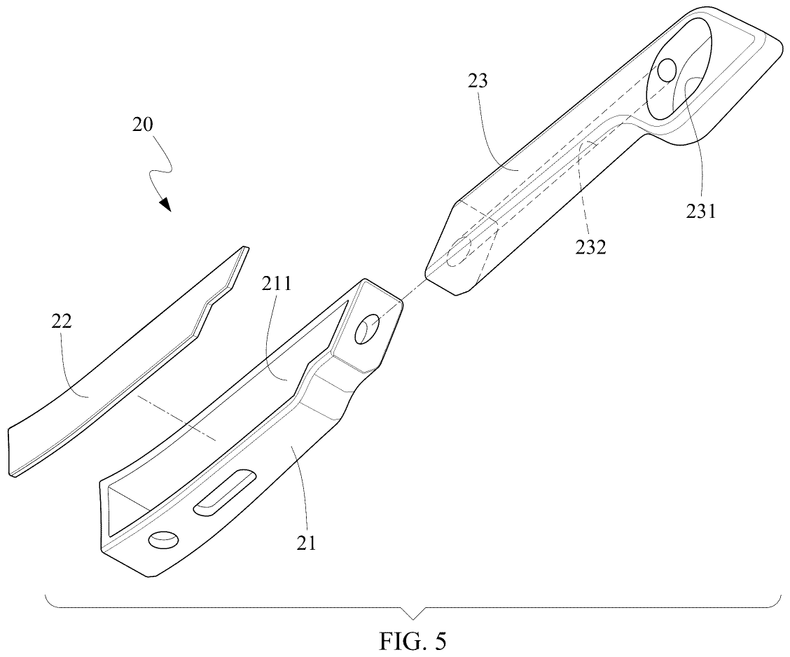

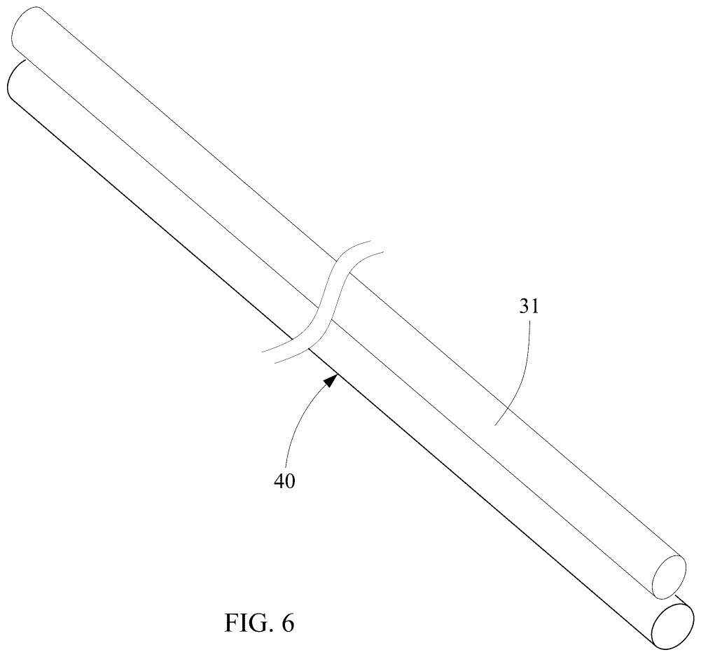

Referring to FIGS. 1 to 6, glasses include a frame 10, two temples 20, two bone-conduction oscillators 30, and two flexible metal wires 40 according to the preferred embodiment of the present invention.

The frame 10 (the prior art) is made with a pre-determined profile. In use, the frame 10 supports lenses (the prior art).

The temples 20 are respectively pivotally connected to two ends of the frame 10. Each of the temples 20 includes a hard shell 21, a side cover 22 and a soft shell 23.

The hard shell 21 is connected to the frame 10 at an end and includes a chamber 211.

The chamber 211 is made in an internal side of the hard shell 21. Preferably, the chamber 211 receives accessories such as an electric panel A1 and a battery A2 (the prior art).

The side cover 22 is connected to the hard shell 21 to close the chamber 211.

The soft shell 23 is connected in series to the hard shell 21 at an end and includes a recess 231 and a channel 232. Preferably, via selecting proper materials, the soft shell 23 is made with elasticity to allow physical deformation.

The recess 231 is made in an internal side of the soft shell 23 and is arranged at one end of the hard shell 21 far away.

The connecting passage 232 is made in the soft shell 23, thereby connecting the recess 231 of the soft shell 23 to the chamber 211 of the hard shell 21.

Each bone-conduction oscillator 30 (the prior art) is inserted in the recess 231 of the soft shell 23 of a corresponding temple 20 and is connected to the electrical panel A1 in the chamber 211 via at least one wire 31 which extends in the channel 232.

Each flexible metal wire 40 can be bent and kept in the bent position and connects a corresponding bone-conduction oscillator 30 to the hard shell 21 of a corresponding temple 20. Each flexible metal wire 40 extends in the channel 232 of the soft shell (23) of the corresponding temple 20 to allow a user to arbitrarily bend the soft shell (23) of the corresponding temple 20 and synchronously keep it in the bent position.

As described above, the glasses according to the preferred embodiment of the present invention is assembled by putting together the components. The operation of the glasses according to the preferred embodiment of the present invention will be described as follows.

The user can wear the glasses and use the bone-conduction oscillators 30 to listen to music. When the positions of the bone-conduction oscillators 30 are not good, the user can bend the flexible metal wires 40, which extend in the soft shells 23 of the temples 20 so that the bone-conduction oscillators 30 are moved to proper positions adjacent to the user's ears.

The soft metal wires 40 are used to keep the soft shells 23 in bent positions to locate the bone-conduction oscillators 30 in positions suitable for the user.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. Glasses including:
a frame (10) made with a predetermined profile;
two temples (20) connected to two ends of the frame (10), wherein each of the temples (20) includes a hard shell (21) at an end and a soft shell (23) at another end;
wherein the hard shell (21) is pivotally connected to the frame (10) at an end and includes a chamber (211) in communication with exterior of the hard shell (21);
wherein the soft shell (23) is flexible and connected in series to the hard shell (21) and includes a recess (231) and a channel (232) for connecting the recess (231) to the chamber (211);
two bone-conduction oscillators (30) inserted in the recesses (231), wherein each of the bone-conduction oscillators (30) includes at least one wire (31) extending to the chamber (211) through the channel (232); and
two flexible metal wires (40) extending along the channels (232), wherein each of the flexible metal wires (40) includes an end connected to a corresponding one of the bone-conduction oscillators (30) and another end connected to a corresponding one of the hard shells (21), wherein the flexible metal wires (40) are bendable and keepable in bent positions.

2. The glasses according to claim 1, wherein each of the temples (20) further includes a side cover (22) for attached to the hard shell (21) to close the chamber (211).
